(19) United States
(12) Patent Application Publication
(10) Pub. No.: US 2005/0021390 A1
(43) Pub. Date: Jan. 27, 2005

(54) Rating an item

(76) Inventors: Dan Porter, Portland, ME (US); Samuel Pierce, Falmouth, ME (US)

Correspondence Address: FISH & RICHARDSON PC, 225 FRANKLIN ST, BOSTON, MA, 02110, US

(21) Appl. No.: 10/861,832

(22) Filed: Jun. 3, 2004

Related U.S. Application Data
(60) Provisional application No. 60/475,647, filed on Jun. 3, 2003.

(51) Int. Cl. G06F 17/60

(52) U.S. Cl. 705/10; 705/1

(57) ABSTRACT

A method of rating an item includes receiving an item selected by a user, receiving a first profile associated with a first criteria, receiving a second profile associated with a second criteria, and rating the item based on the first profile and the second profile. Rating the item may include retrieving values associated with the item. The values include values associated with the first criteria and values associated with the second criteria. Rating the item may also include applying the first profile to the values associated with the first profile and applying the second profile to the values associated with the second profile. The method may also include receiving from a user an indication of how to interpret a value and evaluating the value positively or negatively based on the indication.

### RELATED APPLICATIONS

This application claims priority from and incorporates herein U.S. Provisional Application No. 60/475,647, filed Jun. 3, 2003, and titled “RANKING COMPANIES”.

### BACKGROUND

Information about social, environmental, and other corporate practices has been collected and distributed since the 1970s by investment funds, consumer-information organizations and research firms. Typically, the information is used to quantify the relative performance of companies on issues of corporate practices such as management diversity, involvement with repressive international regimes, environmental destructiveness and cruelty to animals in product testing and so forth.

Companies have also been evaluated separately based on their financial performance. For example, brokerage firms, financial institutions and investment firms typically issue ratings on equities based on past, present or projected performance.

### SUMMARY

In one aspect, the invention is a method of rating items. The method includes receiving an item selected by a user, receiving a first profile associated with a first criteria, receiving a second profile associated with a second criteria, and rating the item based on the first profile and the second profile.

In another aspect, the invention is an apparatus for rating an item. The apparatus includes a memory that stores executable instructions and a processor. The processor executes the instructions to receive an item selected by a user; receive a first profile associated with a first criteria; receive a second profile associated with a second criteria; and rate the item based on the first profile and the second profile.

In still another aspect, the invention is an article. The article includes a machine-readable medium that stores executable instructions for rating an item. The instructions cause a machine to receive an item selected by a user; receive a first profile associated with a first criteria; receive a second profile associated with a second criteria; and rate the item based on the first profile and the second profile.

In another aspect, a method for rating an item, includes receiving from a user an indication of how to interpret a data value and evaluating the data value positively or negatively based on the indication.

In another aspect, an apparatus for rating an item includes a memory that stores executable instructions and a processor that executes the instructions to receive from a user an indication of how to interpret a data value and to evaluate the data value positively or negatively based on the indication.

In still another aspect of the invention, an article includes a machine-readable medium that stores executable instructions for rating an item. The instructions cause a machine to receive from a user an indication of how to interpret a data value and to evaluate the data value positively or negatively based on the indication.

The aspects above may have one or more of the following features. The first profile may be selected by a user. Rating the item may include retrieving values associated with the item. The values may include values associated with the first criteria and values associated with the second criteria. Rating an item may also include applying the first profile to the values associated with the first profile and applying the second profile to the values associated with the second profile.

The method may also include receiving from the user an indication of how to interpret the values and evaluating a value positively or negatively based on the indication. The method may include weighting the first criteria and the second criteria based on a user's selected weighting.

The second profile may be selected by the user or the second profile may be a default profile. The first profile may be a default profile.

The item may include companies from an industry, companies within an index. The index may be the Dow Jones Industrial Average or the index may be another index.

The first criteria may include includes categories, and rating the item may include determining the rating of the item based on a weighting of the categories. The first criteria may include a corporate practices criteria and the second criteria may include a financial criteria.

The aspects above may have one or more of the following advantages. Items may be evaluated and rated based on multiple criteria. For example, an investor or a socially active group may make equity investments based on a company's corporate practices and the company's financial performance. Other advantages include allowing a user to control the importance and interpretive meaning of values associated with the multiple criteria.

### DESCRIPTION OF THE DRAWINGS

FIG. 1 is a block diagram of a item rating system.

FIG. 2 is a block diagram of a database in the item rating system.

FIGS. 3A-3C is a screenshot of depicting a liberal profile.

FIGS. 4A-4B is a screenshot depicting a conservative religious profile.

FIG. 5 is a flowchart of a process for rating items.

FIG. 6 is a screenshot of a hypertext markup language (HTML) input form.

FIG. 7 is a screenshot of a conservative religious profile HTML edit form.

FIG. 8 is a screenshot of a growth investor profile HTML edit form.

FIG. 9 is a screenshot of an HTML results form comparing selected companies to companies in the same industry.

FIG. 10 is a screenshot of an HTML results form with weighting different from FIG. 9.

FIG. 11 is a screenshot of an HTML results form comparing selected companies to all companies stored in the item rating system.

FIG. 12 is a screenshot of an HTML results form for companies within the semiconductor industry.

FIG. 13 is a block diagram of a computer system on which the process of FIG. 5 may be implemented.

### DESCRIPTION

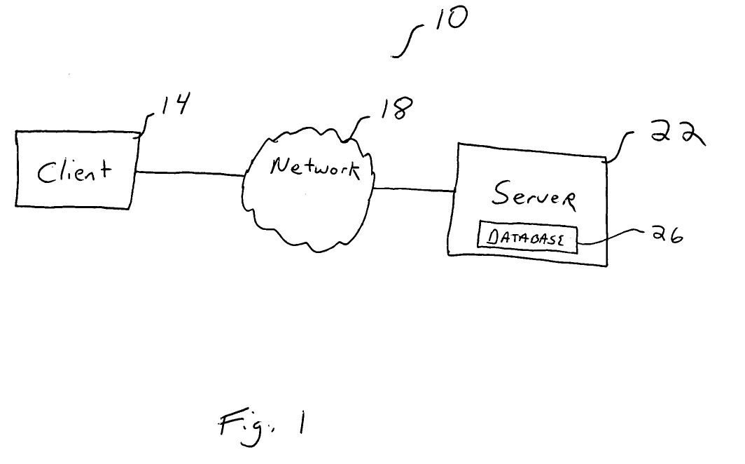

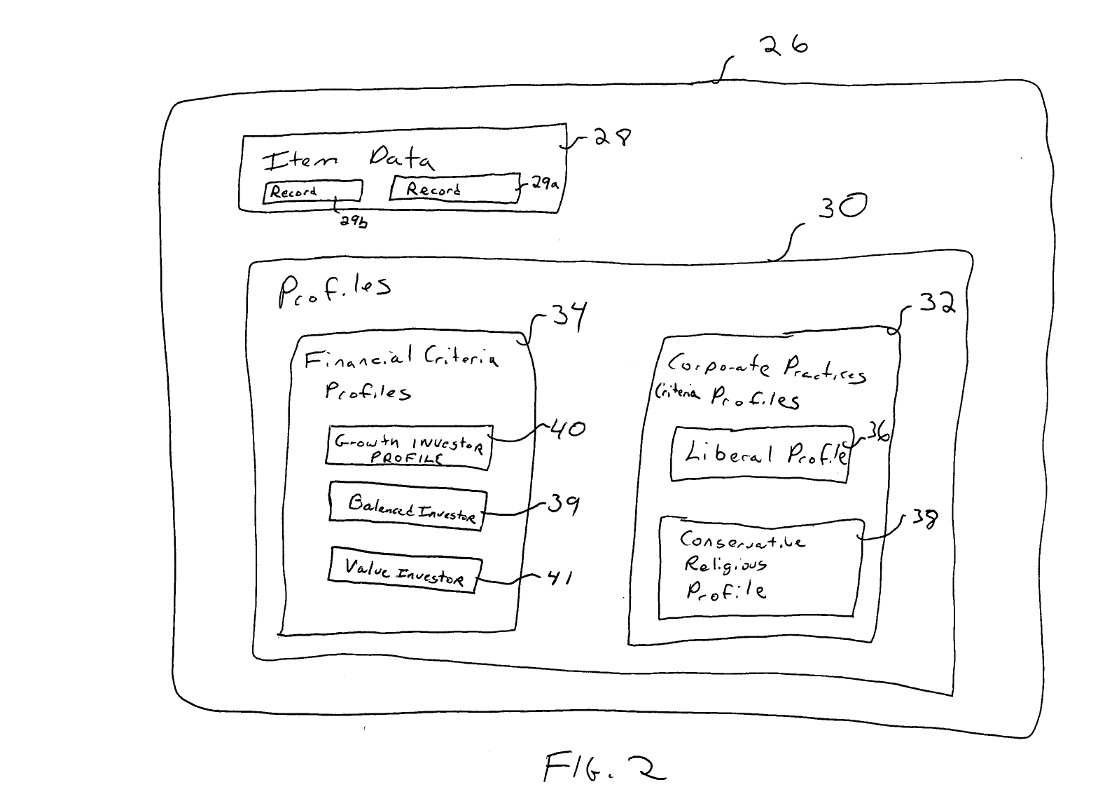

Referring to FIGS. 1 and 2, an item rating system includes a client 14 connected to a server 22 through a network 18. The network 18 may be a global network (e.g., the Internet), a wide area network, a local area network and so forth. Server 22 includes a database 26, which stores item data 28 and profiles structure 30. As will be described further, a user using client 14, accesses server 22 to receive ratings on items from the items data 28 associated with criteria (e.g., corporate practices, financial performance, and so forth). The ratings are determined based on weightings determined by the user for each criteria and the profiles 28 selected by the user. The user may change the criteria weightings, the composition and importance of each aspect of the profile (i.e., categories within the criteria) as well as modify interpretative aspects of the profile by system 10 (i.e., modify subcategories within the categories). While system 10 is used to rate companies based on a corporate practices criteria and a financial criteria, other items and criteria may be chosen.

The item data 28 includes records (e.g., record 29a, record 29b) having values associated with each item that is covered or rated by the server 22, as described below. The item may be a legal entity such as a company, a group of companies (e.g., a stock index, a Standard & Poor's 500, an industry and so forth). Alternatively the item can be a brand, a product, an individual, a group of individuals, and so forth. The values in each record 29a and 29b are associated with at least one criteria and at least one item. The criteria include categories and each category include subcategories. A value is assigned to each subcategory for the criteria included in the record and for each item included within the record. Records 29a and 29b may be a flat file or any data structure for storing values.

For example, each item is a company and one of the criteria is a corporate practices criteria. A category associated with the corporate practices criteria may be a workplace category. Subcategories associated with the workplace category include for example a “Fortune 100 rank” subcategory and a “Working Mother's top 100 rank” category and so forth. A value is assigned to the Fortune 100 rank subcategory based on a company's ranking in the Fortune 100 and a value is assigned to the Working Mother's top 100 rank subcategory based on a company's ranking in the Working Mother's top 100, (e.g., the higher the ranking the higher the assigned value).

The profiles structure 30 includes profiles for multiple criteria that are used to evaluate or rank the item. A profile designates which categories, of all the possible categories for the criteria, that are included in the profile; a weighting of the categories included in the profile; and exclusions of items based on thresholds designated in some categories. Details of these features are set forth below.

Profiles structure 30 include a corporate practices criteria profiles 32 and a financial criteria profiles 34. The financial criteria profiles 34 includes a balanced investor profile 39, a growth investor profile 40 and a value investor profile 41. The corporate practices criteria profiles 32 include a liberal profile 36 and a conservative religious profile 38.

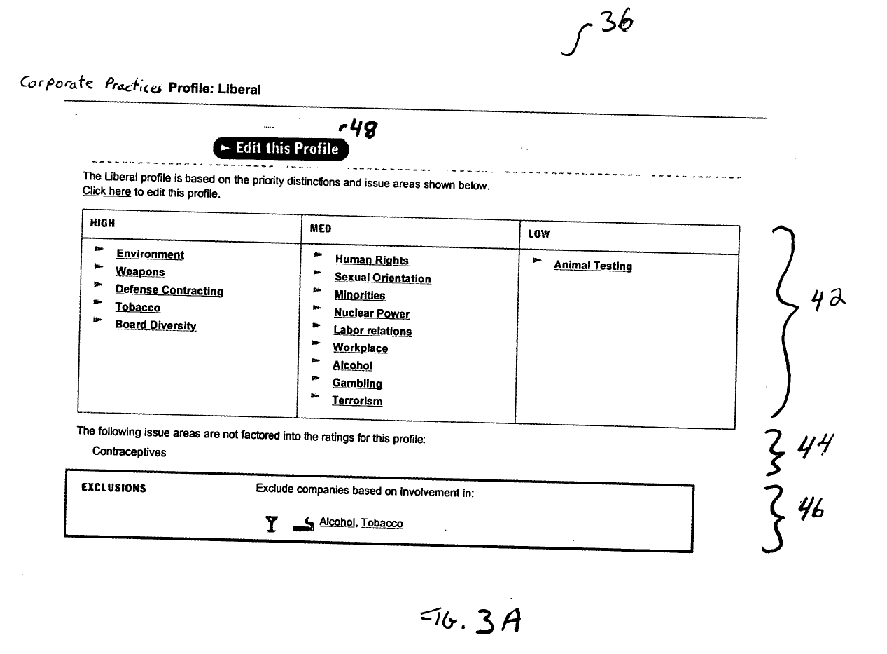

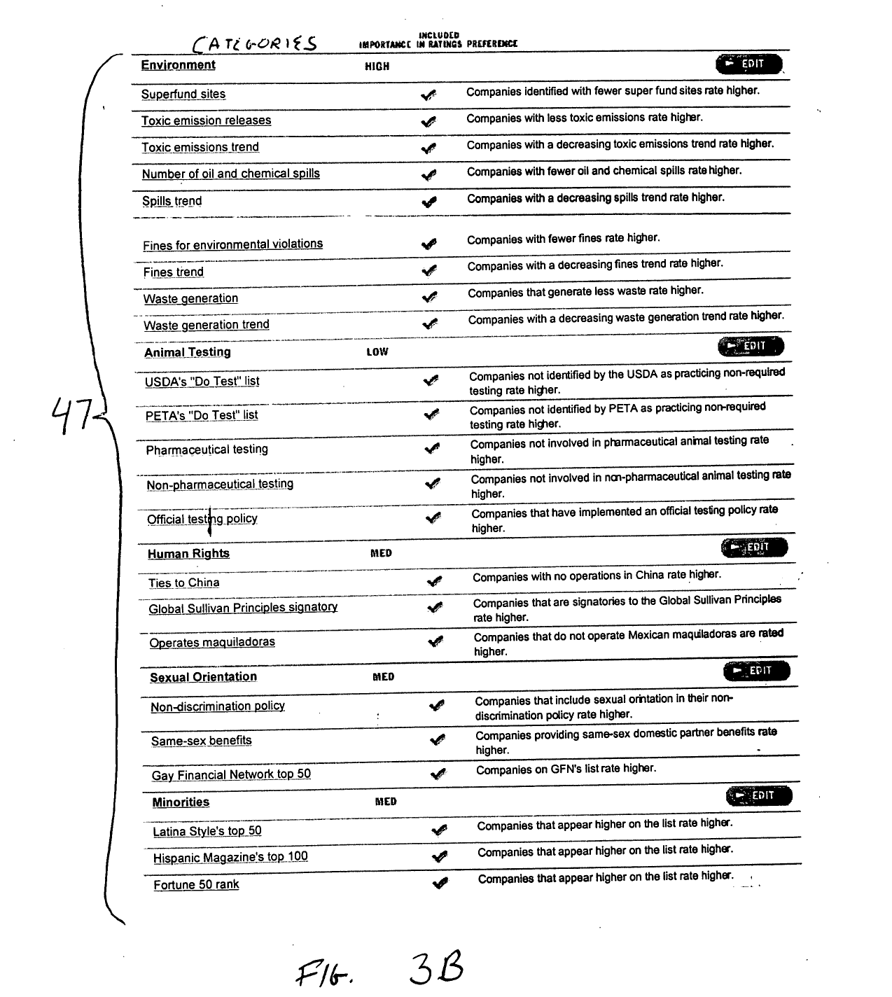

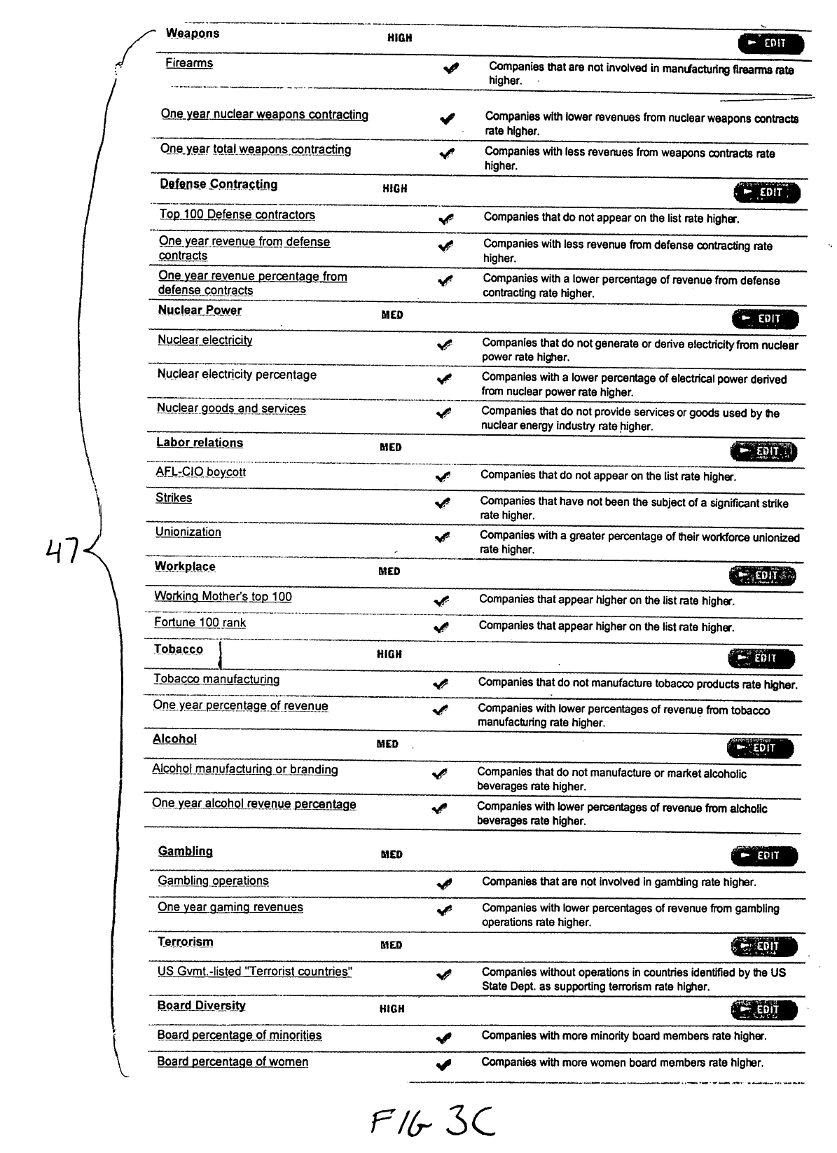

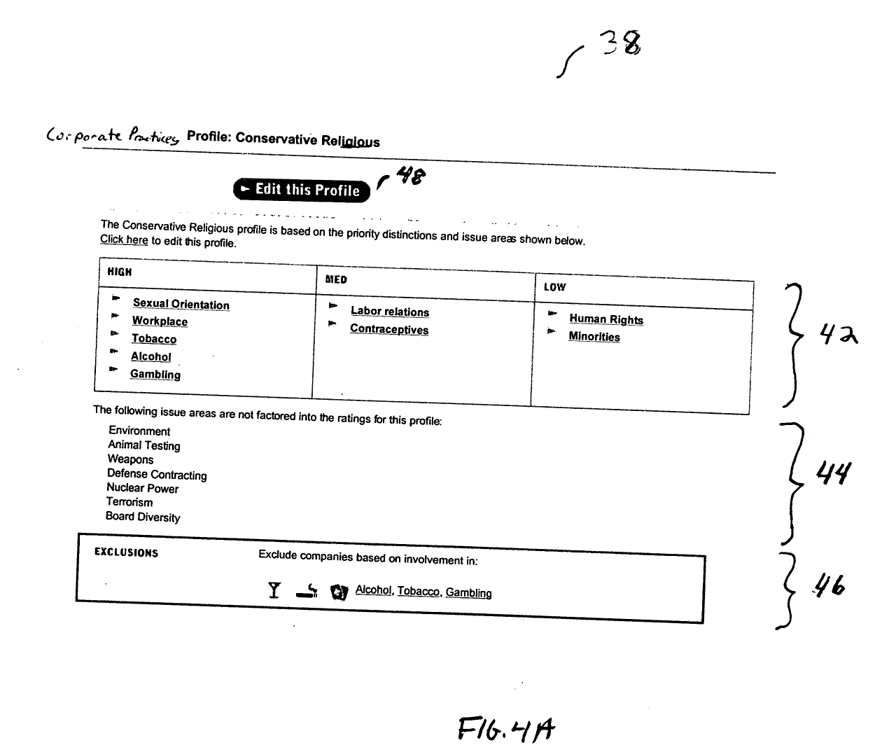

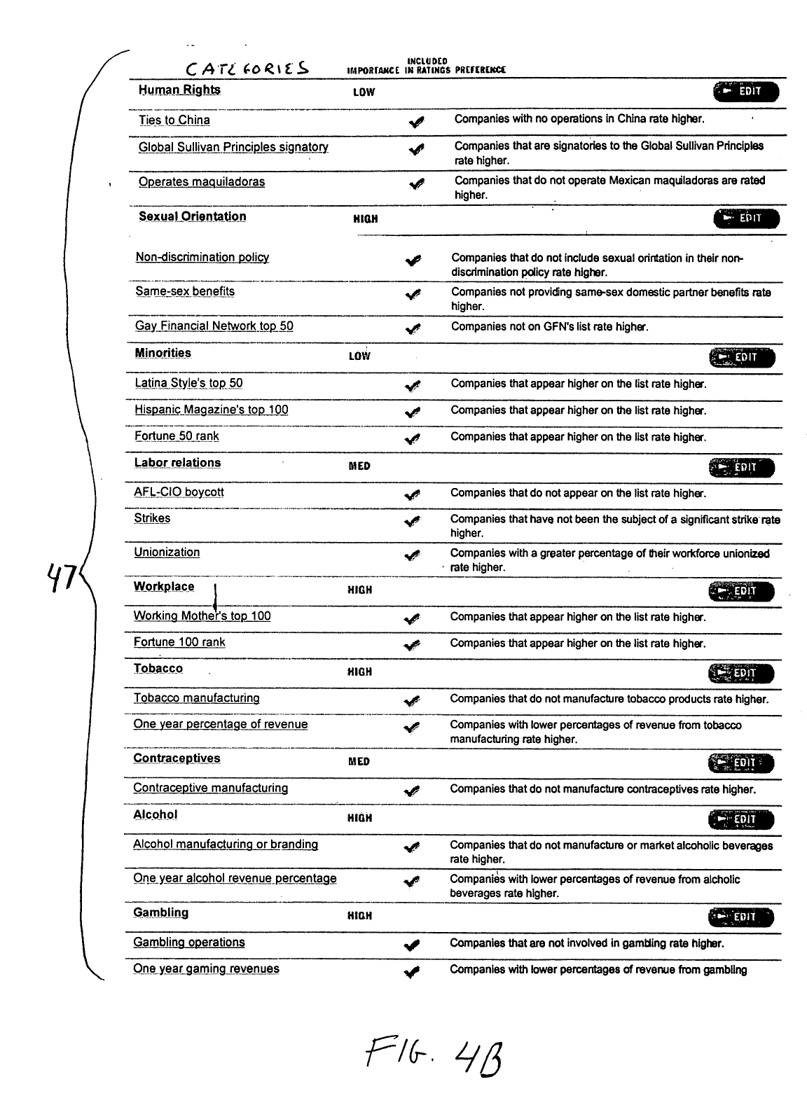

FIGS. 3A-3C show an example of the liberal profile 36 depicted as a hypertext mark-up language (HTML) page and FIGS. 4A-4B show an example of the conservative profile 38 depicted as an HTML page. Profiles 36 and 38 include a priority section 42, an omitted category section 44, an exclusions section 46, a categorical details section 47, and an “Edit Profile” button 48. Profile 36 and 38 are examples of possible profiles. Other profiles may be designated or used within system 10.

A profile may include one or more of all the possible categories within a criteria. The omitted category section 36 lists the categories that are omitted from being used in the rating and received a “none” priority. For example, the corporate practices criteria profiles 32 includes a contraceptive category, an environment category, a human rights category, an animal testing category, an alcohol category, a tobacco category and so forth. The liberal profile 36 does not include the contraceptives category and the conservative religious profile 38 does not include the environment category.

The categories included in the profile are weighted. The priority section 42 lists the priority of each category as “low”, “medium” or “high.” For example, the liberal profile 36 weights the human rights category “high,” the alcohol category as “low” and the tobacco category as “high”. The conservative religious profile 38 weights the human rights category “low,” the alcohol category “high” and the tobacco category “high.”

Each profile 36 and 38 may exclude items from consideration in the rating process based on the item meeting certain thresholds associated with a particular category. The exclusions section 38 lists the categories for excluding companies that participate in these categories. For example, the liberal profile 32 excludes companies based on a company's involvement with alcohol. The categorical details section 47 lists the categories, the priority of each category listed, the subcategories included with each category listed and the preference of each subcategory. As will be shown below, the “Edit Profile” button 48 may be used to change the profile.

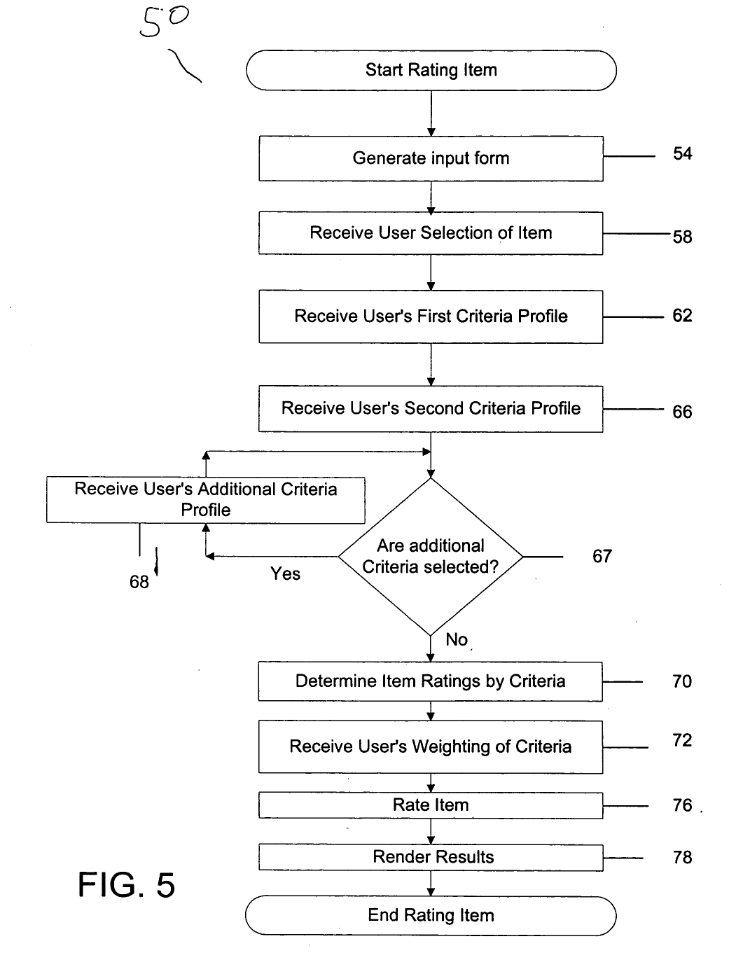

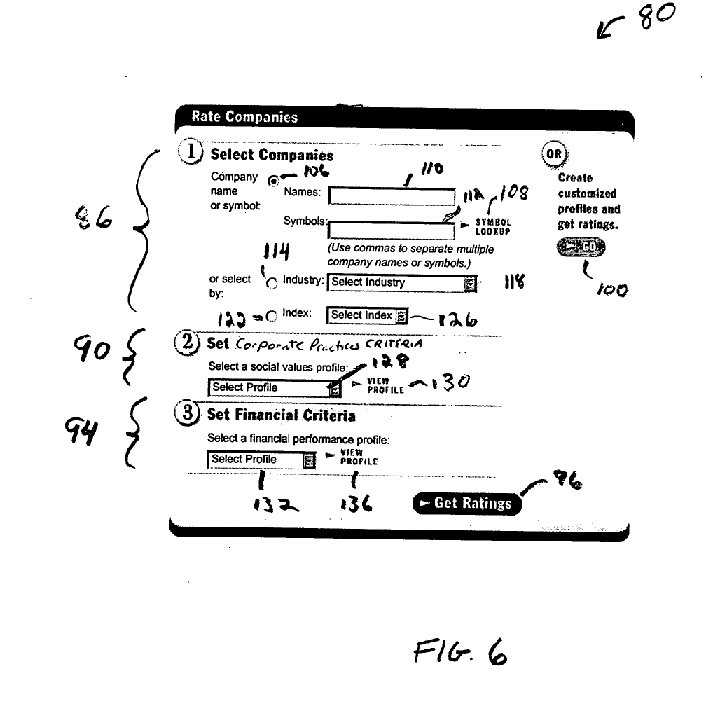

Referring to FIG. 5, and as needed FIGS. 6-10, a process 50 rates an item based on more than one criteria. In one embodiment, process 50 may be used to rate companies based on corporate practices criteria and financial criteria in order for a user to select which companies to invest their money. For example, process 50 may rate companies or groups of companies (e.g., portfolios, industries, mutual finds) based on two criteria: financial performance criteria and corporate practices criteria.

Process 50 generates (54) an input form. For example, the input form is a hypertext mark-up language (HTML) input form 80. HTML input form 80 includes a company selection section 86, a corporate practices criteria section 90, a financial criteria section 94, a “Get Ratings” button 96 and a custom selection button 100 each of which are described in more detail below.

Process 50 receives (58) the user's selection as to which items to rate. For example, the user selects which companies to rate from the company selection section 86. Company selection criteria 86 includes a radio button 106 to select a company by name or symbol, a “Symbol Lookup” button 108, a box 110, a box 112, a radio button 114 to select an industry, a menu 118, a radio button 122 and a menu 126. The user may enter companies by selecting the radio button 106 using a mouse, for example, and by selecting box 110 using a mouse and then using a keyboard to enter a company name into box 110 or by selecting box 112 to enter a stock symbol. The user may also use “Symbol Lookup” hypertext 108 to search for stock symbols by company name.

The user may also select companies by industry by selecting a radio button 114 and selecting an industry from a menu 118 using the mouse, for example. The industry may include semiconductors, medical equipment, financial services and so forth.

The user may further select companies by selecting a radio button 122 and selecting a stored group such as an index, portfolio, managed account, or mutual fund from a menu 126. In other examples, the stored groups may vary in different applications of the invention. Users may import lists or groups and save these for future use.

Process 50 receives (62) a user's first criteria profile. For example, process 50 receives a corporate practices criteria profile 32 that a user selects from the corporate practices criteria section 90. Corporate practices criteria section 90 includes a corporate practices profile menu 128 and a “View Profile” hypertext 130. The user selects profile menu 128 to choose a corporate practices criteria profile 32. Corporate practices profile menu 86 may include profiles generated and saved by the user or profiles already within system 10. The profiles may include a moderate conservative profile (not shown), the liberal profile 36, a human rights profile (not shown), an environmental profile (not shown), the conservative religious profile 38, an animal right profile (not shown) and so forth.

Each corporate practices criteria category within a profile is weighted by importance with respect to the other corporate practices categories depending on the corporate practices profile. For example, the weight may be “high”, “medium”, “low” or “none”. By selecting “View Profile” hypertext 130, the user may view the weights for each corporate practices profile. For example, selecting “View Profile” hypertext 130 for the conservative religious profile renders the conservative religious profile HTML page depicted in FIG. 4.

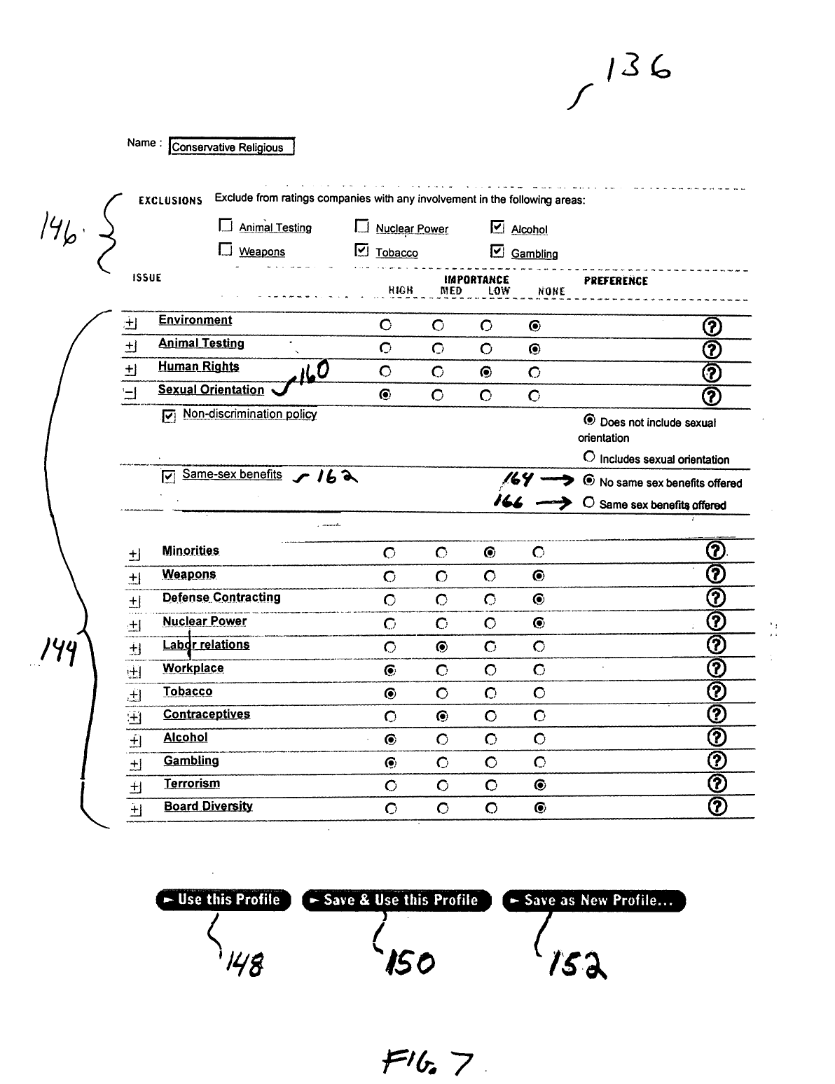

Referring to FIG. 7, the user may also modify an existing profile. For example, a conservative religious profile 36 may be modified by selecting the “Edit Profile” button 48 (FIG. 4). A conservative religious HTML edit form 136 includes a category weighting section 144, an exclusions section 146, a “Use this Profile” button 148, a “Save and Use this Profile” button 150 and a “Save as a New Profile” button 152. In the category weighting section 144 the user select the importance of each category by selecting whether the category is a “high” priority, a “medium” priority, a “low” priority or “none” by selecting a corresponding radio button for each category.

The user determines the impact each subcategory has by choosing how the data in that subcategory is interpreted. Users with different or even antithetical perspectives may receive meaningful results from the same criteria. For example, the sexual orientation category 160 may include a same-sex benefits subcategory 162. The same-sex benefits subcategory 162 if used in a corporate practices criteria profile 32 may further indicate whether the company is involved or not involved in same-sex benefits. For example, the conservative religious profile 38 would indicate a favorable rating if there are no same-sex benefits. The liberal profile 36 would indicate a favorable rating if there are same-sex benefits at a company. The user may select radio button 164 to indicate that if no same sex benefits are at a company offered as being favorable. For example, a high value would be given to companies in this subcategory if the company had no same sex benefits while a low value would be given to a company that does offer same sex benefits. Alternatively, the user may select radio button 166 to indicate that same sex benefits offered at a company as being favorable. For example, a high value would be given to companies in this subcategory if the company had same sex benefits while a low value would be given to a company that does not offer same sex benefits. On a scale from “1” to “10”, a high value may be “10”, “9” or “8” and a low value may be “1”, “2” or “3”, for example.

The user may generate new corporate practices profiles by making changes to an existing profile and saving the changed existing profile as a new profile by selecting the “Save as New Profile” button 152. The user may modify the existing corporate practices profile by selecting the profile to be edited, editing the profile and saving the profile by selecting the “Save & Use this Profile” button 150.

The user may use the corporate practice profile without saving the changes by selecting the “Use this Profile” button 148.

Process 50 receives (66) a user's second criteria profile. Financial criteria section 50 includes a financial profile menu 90 and a “View Profile” hypertext 92. Financial profile menu 90 may include the growth investor profile 40, the value investor profile 41 and the balanced investor profile 39. Each of these financial profiles has a list of financial categories. For example, these financial categories include a historical performance category, Morningstar grade category and so forth. Each financial category is weighted by importance with respect to the other financial categories depending on the profile. For example, the weight may be “high”, “medium”, “low” or “none”. By selecting “View Profile” hypertext 136, the user may view the weights for each financial profile.

Each financial category includes subcategories. For example, the historical performance category may include a 1-month return subcategory, a year-to-date return category, a price/book ratio subcategory and so forth.

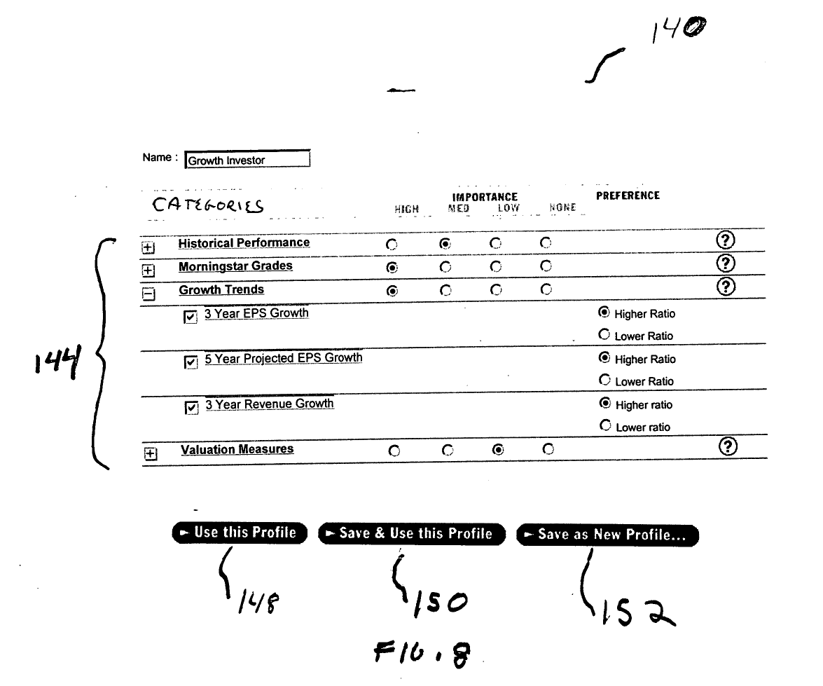

Referring to FIG. 8, the user may modify the existing financial criteria profiles 35 by using the “Edit Profile” button 48 in the corresponding HTML profile (not shown) to render a growth investor HTML edit form 140. The growth investor HTML edit form 140 includes a category weighting section 144, an exclusions section 146, a “Use this Profile” button 148, a “Save and Use this Profile” button 150 and a “Save as a New Profile” button 152. The user may edit the growth investor HTML edit form 140 in a similar manner as the conservative religious HTML edit form 136 may be edited above.

Process 50 determines (67) if additional criteria are selected by the user. If additional criteria are selected by the user, process 50 receives (68) a profile associated with the additional criteria.

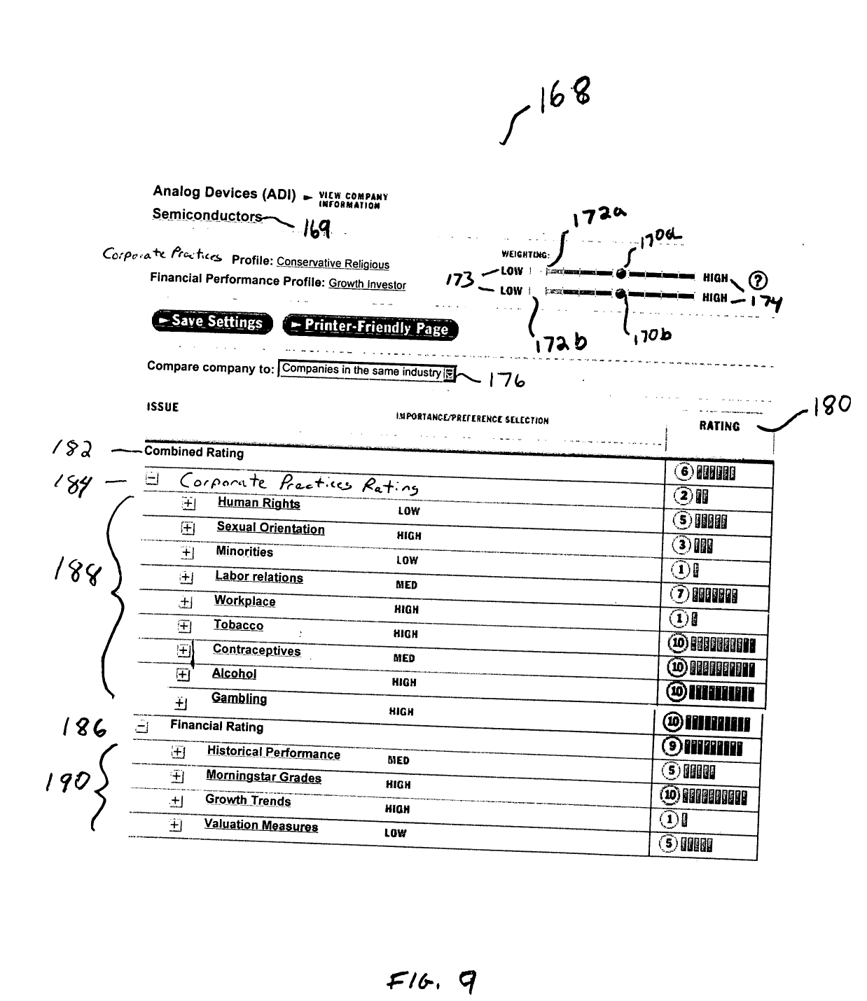

Referring also to FIG. 9, if additional criteria are not selected by the user or available to the user, process 50 determines (70) a company's ratings after the user has selected “Get Ratings” Button 96 by selecting button 96 with the mouse.

A results HTML page 168 includes a radio button 170a, a radio button 170b, a scale 172a, a scale 172b, an industry hypertext 169, a pull-down menu 176, a rating column 180, a combined rating score 182, a corporate practices score 184, a financial rating score 186, a corporate practices categories 188, and a financial categories 190.

In one example, each of the subcategories of a category receive a normalized score between “1” and “10” with “1” being the lowest and “10” being the highest score. A preliminary score for each category is calculated by averaging the subcategories. Each category scored is normalized based on the pool the company is being compared to. For example, in FIG. 9 each category rating is normalized between “1” and “10” for companies in the semiconductor industry.

The overall criteria rating is calculated by weighting each of the categories preliminary scores based on the priority chosen. For example, categories with a “high” priority receive a weighting factor of 4, a “medium” priority receives a weighting factor of 2, and a “low” priority receives a weighting factor of 1.

For example, the user selected Analog Devices. The user has selected the conservative religious profile 38 and the growth investor profile 40. Based on these inputs, Analog Devices receive a corporate practice rating 184 of “2” and a financial rating 186 of The overall combined rating 182 is calculated by weighting the corporate practices rating and the financial rating. Initially, weightings are defaulted to be equal so that the overall rating is initially the average of the corporate practices rating and the financial rating or “6”.

Process 50 receives (72) receives the user's selection of weightings for each criteria. For example, the weights between the corporate practices rating 184 and the financial rating 186 each may be adjusted separately. For example, a corporate practices weighting may be adjusted by selecting radio buttons 170a with a mouse along a low-to-high scales 172a and the financial weighting may be adjusted by selecting radio buttons 170b with a mouse along a low-to-high scales 172b. A “low end” 173 of the scales 172a and 172b receives a weighted factor of “1” and each increment of the scales increase by one to a “high end” 174 of the scales which receives a weighting factor of “10”.

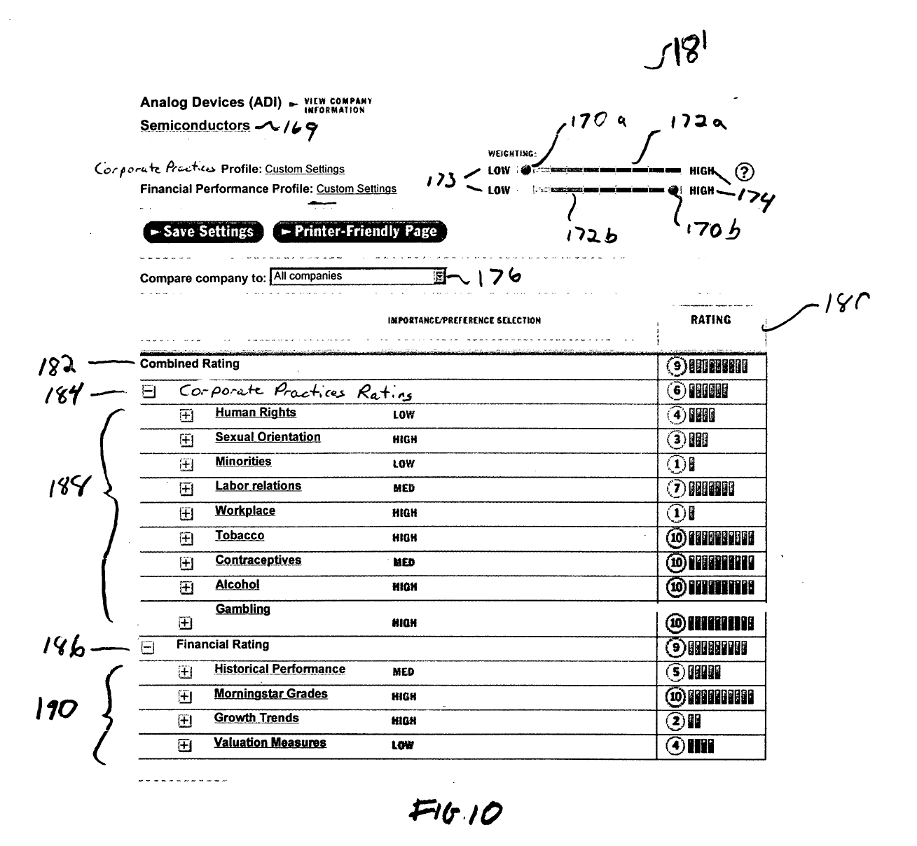

Referring to FIG. 10, process 50 rates (76) the item based on the weightings and renders (78) the results in an HTML results form 181. The results are based on the corporate practices profiles chosen for the corporate practices criteria and the financial profile chosen for the financial criteria for the companies selected.

For example, modifying the HTML results form 168 in FIG. 9 by taking the weighting of the corporate practices weighting factor to be the lowest on the scale 172a and the financial weighting to be the highest on the scale 172b, the overall combined rating 182 is (2×1+9×10)/10 or “9”.

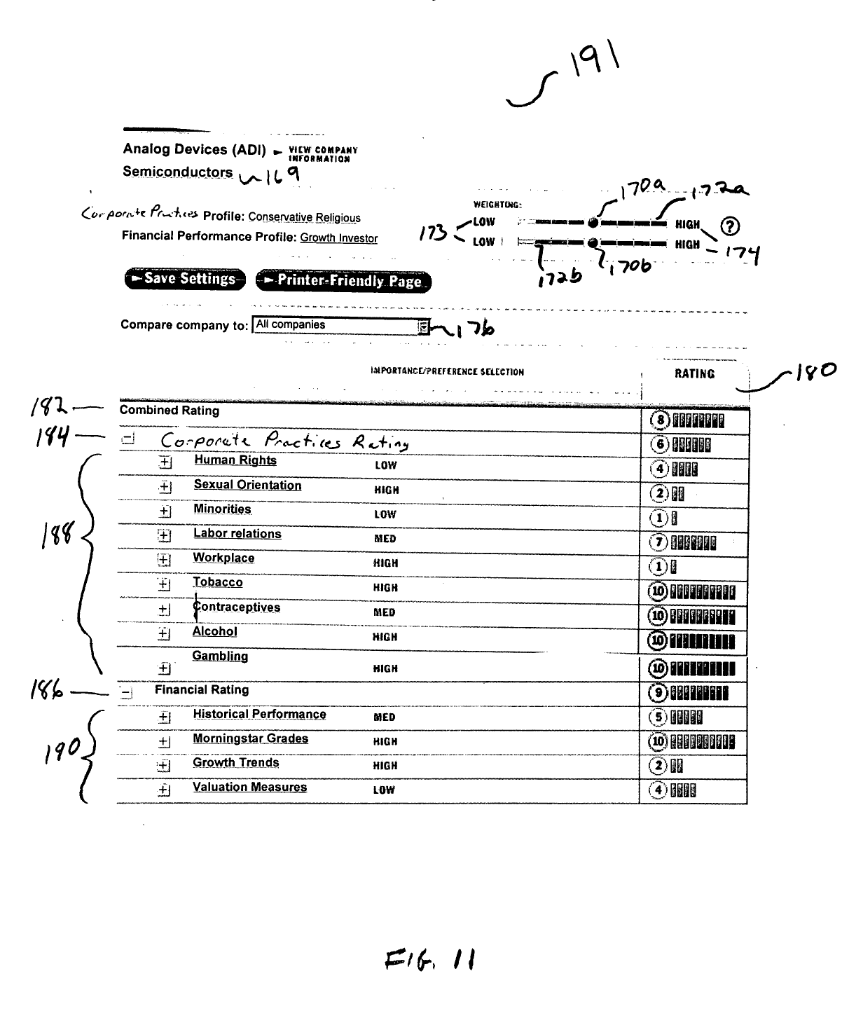

Referring to FIG. 11, an HTML results form 191 may include a comparison of the selected companies with all companies (within database 26) by selecting the pull-down menu 176. The results of each category and the overall score for the criteria have been normalized against all the companies in database 26.

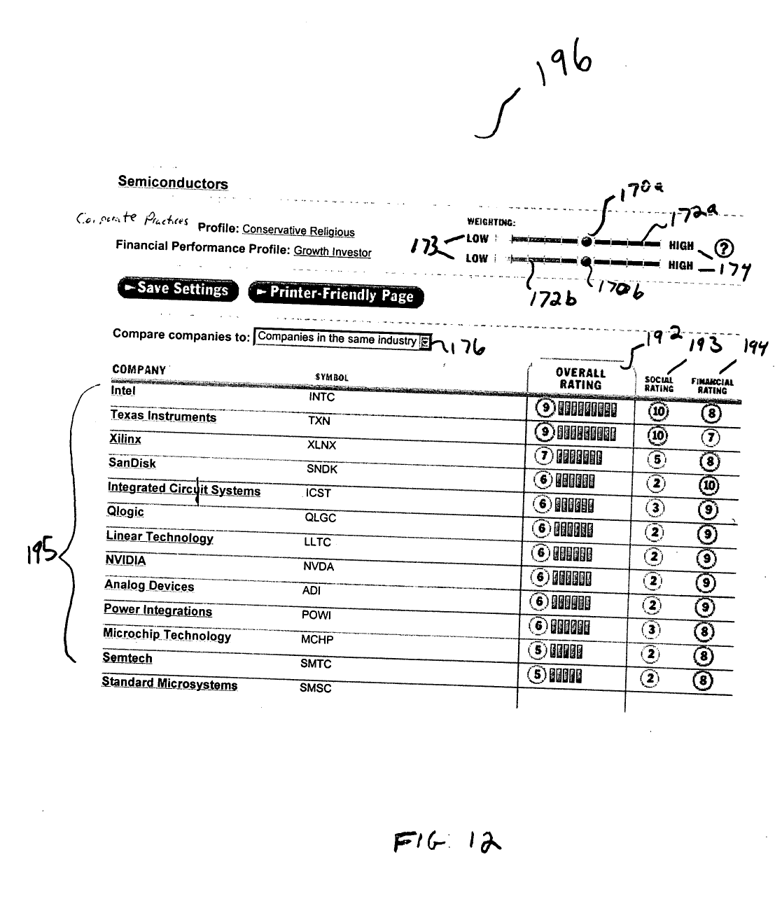

Referring to FIG. 12, an HTML results form 196 may include a comparison of the selected companies with companies in the same industry by selecting the industry hypertext 169. The HTML results form 196 includes an overall rating column 192, a corporate practices rating column 193 and a financial rating column 194, and a company section 195.

For example, companies within the semiconductor industry are listed in company section 195 with their corresponding corporate practices rating under the corporate practices column 195, their financial rating under the financial rating column 194 and their overall combined rating under the overall rating column 192.

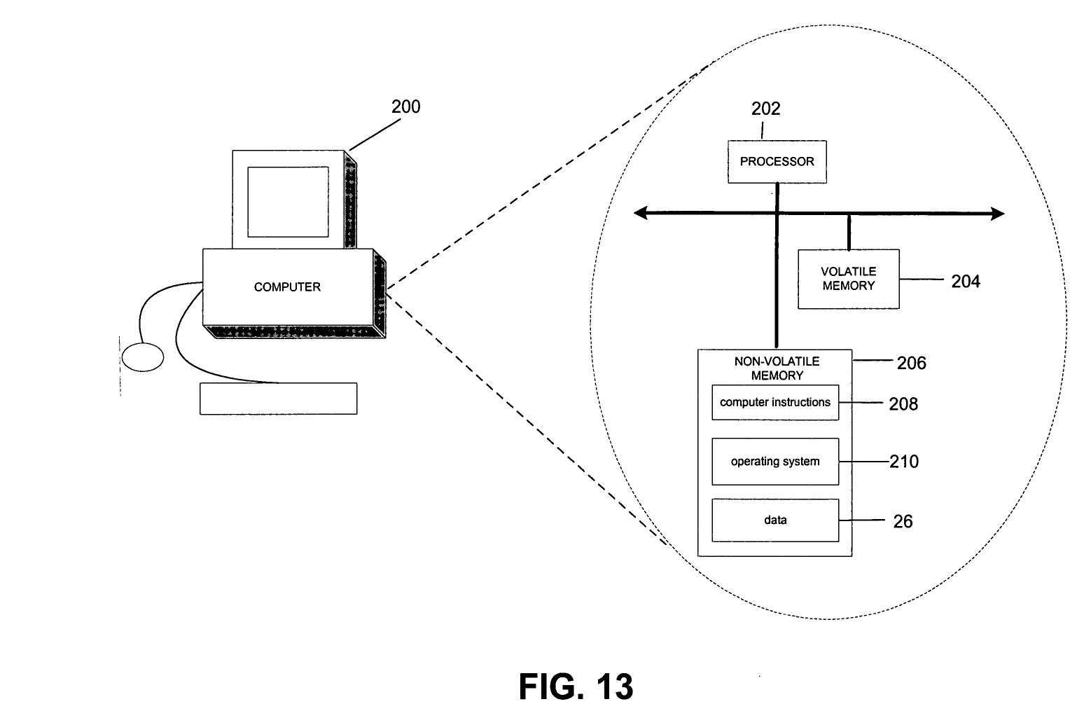

FIG. 13 shows a computer 200 for rating items using process 50. Computer 200 includes a processor 202 for ranking items, a memory 204, and a storage medium 206 (e.g., hard disk). Storage medium 206 stores operating system 210, data 112 for storing the database 26, and computer instructions 108 which are executed by processor 202 out of memory 204 to perform process 50.

Process 50 is not limited to use with the hardware and software of FIG. 13; it may find applicability in any computing or processing environment and with any type of machine that is capable of running a computer program. Process 50 may be implemented in hardware, software, or a combination of the two. Process 50 may be implemented in computer programs executed on programmable computers/machines that each includes a processor, a storage medium/article readable by the processor (including volatile and non-volatile memory and/or storage elements), at least one input device, and one or more output devices. Program code may be applied to data entered using an input device to perform process 50 and to generate output information.

Each such program may be implemented in a high level procedural or object-oriented programming language to communicate with a computer system. However, the programs can be implemented in assembly or machine language. The language may be a compiled or an interpreted language. Each computer program may be stored on a storage medium (article) or device (e.g., CD-ROM, hard disk, or magnetic diskette) that is readable by a general or special purpose programmable computer for configuring and operating the computer when the storage medium or device is read by the computer to perform process 50. Process 50 may also be implemented as a machine-readable storage medium, configured with a computer program, where upon execution, instructions in the computer program cause the computer to operate in accordance with process 50.

The process is not limited to the specific embodiments described herein. For example, process 50 need not be performed on the Internet. For example, process 50 can be used on a wide area network (WAN), a local area network (LAN) or on a stand-alone personal computer based within a retail store. The process is not limited to the data sets or categories described herein. The categories may be in completely different areas such as product quality characteristics, political voting records, and survey information. They may also be in other areas of corporate practices or have other financial performance measures.

The process is not limited to the specific processing order of FIG. 5. Rather, the blocks of FIG. 5 may be re-ordered, as necessary, to achieve the results set forth above. For example, users may not be able to choose one or more of the profiles. Instead, system 10 defaults to predefined profiles.

In other example, items data 28 may be a single flat file or other data structure or a single record containing values for all subcategories for all the criteria and for all the items used in system 10.

Additional features and functionalities may include having a single rating for a group of items that is based on underlying ratings of the constituent elements. For example, this may be a form of portfolio rating, which enables users to establish one or more groups and get overall ratings of the group as well as individual ratings of each of the group members. The portfolio rating may be applied to weighted portfolios, which allows users to account for the percentage of the portfolio made up by each holding. The portfolio rating may also enable users to rate mutual funds or managed accounts using their profiles.

Other features may include a screening feature, which enables users to use criteria or their full profiles to search a selected group or the universe of ratable entities or items for entities or items satisfying the selected criteria. For example, this may be an industry, a sector, an index, a user-identified group, or the universe of ratable companies for investment opportunities that most closely align with the corporate practices criteria and financial criteria selected for a screen. Screening may also be used to generate lists of the best companies in an industry or best companies with respect to certain practices.

A still further feature is a reverse goal-seeking feature, which enables users to identify good alternatives to an existing holding in a portfolio. The reverse goal-seeking feature allows the user to place a query specifying a set of criteria and a particular holding and search for suitable alternatives (e.g., large cap, small cap, growth stock, etc.) that perform better relative to the user's profile.

Other embodiments are also within the scope of the following claims.

1. A method for rating an item, comprising:
receiving the item selected by a user;
receiving a first profile associated with a first criteria;
receiving a second profile associated with a second criteria; and
rating the item based on the first profile and the second profile.

2. The method of claim 1, wherein the first profile is selected by a user.

3. The method of claim 2, wherein rating the item comprises:
retrieving values associated with the item; the values including values associated with the first criteria and values associated with the second criteria;
applying the first profile to the values associated with the first profile; and
applying the second profile to the values associated with the second profile.

4. The method of claim 3, further comprising:
receiving from the user an indication of how to interpret the values; and
evaluating a value positively or negatively based on the indication.

5. The method of claim 2, wherein the second profile is selected by the user.

6. The method of claim 2, wherein the second profile is a default profile.

7. The method of claim 1, wherein the first profile is a default profile.

8. The method of claim 1, wherein the item includes companies from an industry.

9. The method of claim 8, wherein the item are companies within an index.

10. The method of claim 9, wherein the index is a Dow Jones Industrial Average.

11. The method of claim 9, wherein the index is another index.

12. The method of claim 1, further comprising weighting the first criteria and the second criteria based on a user's selected weighting.

13. The method of claim 1, wherein the first criteria includes categories, rating the item comprises determining the rating of the item based on a weighting of the categories.

14. The method of claim 1, wherein the item is a company, the first criteria is a corporate practices criteria and the second criteria is a financial criteria.

15. An apparatus for rating an item, comprising:
a memory that stores executable instructions; and
a processor that executes the instructions to:
receive an item selected by a user;
receive a first profile associated with a first criteria;
receive a second profile associated with a second criteria; and
rate the item based on the first profile and the second profile.

16. The apparatus of claim 15, wherein the first profile is selected by a user.

17. The apparatus of claim 16, wherein to rate the item comprises: retrieving values associated with the item; the values including values associated with the first criteria and values associated with the second criteria; applying the first profile to the values associated with the first profile; and applying the second profile to the values associated with the second profile.

18. The apparatus of claim 17, further comprising executable instructions to: receive from the user an indication of how to interpret the values; and evaluate a value positively or negatively based on the indication.

19. The apparatus of claim 16, wherein the second profile is selected by the user.

20. The apparatus of claim 16, wherein the second profile is a default profile.

21. The apparatus of claim 15, further comprising instructions to weight the first criteria and the second criteria based on a user's selected weighting.

22. The apparatus of claim 15, wherein the item is a company, the first criteria is a corporate practices criteria and the second criteria is a financial criteria.

23. An article comprising a machine-readable medium that stores executable instructions for rating an item, the instructions causing a machine to:
receive the item selected by a user;
receive a first profile associated with a first criteria;
receive a second profile associated with a second criteria; and
rate the item based on the first profile and the second profile.

24. The article of claim 23, wherein the first profile is selected by a user.

25. The article of claim 24, wherein instructions causing the machine to rate the item comprises:
retrieving values associated with the item; the values including values associated with the first criteria and values associated With the second criteria;
applying the first profile to the values associated with the first profile; and
applying the second profile to the values associated with the second profile.

26. The article of claim 25, further comprising instructions causing the machine to:
receive from the user an indication of how to interpret the values; and
evaluate a value positively or negatively based on the indication.

27. The article of claim 24, wherein the second profile is selected by the user.

28. The article of claim 24, wherein the second profile is a default profile.

29. The article of claim 23, further comprising instructions causing the machine to weight the first criteria and the second criteria based on a user's selected weighting.

30. The article of claim 23, wherein the item is a company, the first criteria is a corporate practices criteria and the second criteria is a financial criteria.

31. A method for rating an item, comprising:
receiving from a user an indication of how to interpret a data value; and
evaluating the data value positively or negatively based on the indication.

32. The method of claim 31, further comprising:
receiving an item selected by a user;
receiving a first profile associated with a first criteria; and
rating the item based on the first profile and the second profile.

33. The method of claim 31, further comprising receiving a second profile associated with a second criteria.

34. An apparatus for rating an item, comprising:
a memory that stores executable instructions; and
a processor that executes the instructions to:
receive from a user an indication of how to interpret a data value; and
evaluate the data value positively or negatively based on the indication.

35. The apparatus of claim 34, further comprising instructions to:
receive an item selected by a user;
receive a first profile associated with a first criteria; and
rate the item based on the first profile and the second profile.

36. The apparatus of claim 34, further comprising instructions to receive a second profile associated with a second criteria.

37. An article comprising a machine-readable medium that stores executable instructions for rating an item, the instructions causing a machine to:
receive from a user an indication of how to interpret a data value; and
evaluate the data value positively or negatively based on the indication.

38. The article of claim 37, further comprising instructions causing a machine to:
receive an item selected by a user;
receive a first profile associated with a first criteria; and
rate the item based on the first profile and the second profile.

39. The article of claim 37, further comprising instructions causing a machine to receive a second profile associated with a second criteria.
